(19) United States
(12) Patent Application Publication
(10) Pub. No.: US 2016/0034811 A1
(43) Pub. Date: Feb. 4, 2016

(54) EFFICIENT GENERATION OF COMPLEMENTARY ACOUSTIC MODELS FOR PERFORMING AUTOMATIC SPEECH RECOGNITION SYSTEM COMBINATION

(71) Applicant: Apple Inc., Cupertino, CA (US)

(72) Inventors: Matthias PAULIK, San Jose, CA (US); Mahesh KRISHNAMOORTHY, Cupertino, CA (US)

(21) Appl. No.: 14/503,028

(22) Filed: Sep. 30, 2014

Related U.S. Application Data
(60) Provisional application No. 62/031,686, filed on Jul. 31, 2014.
(60) Provisional application No. 62/039,332, filed on Aug. 19, 2014.

(51) Int. Cl. G06N 3/08; G06N 3/04

(52) U.S. Cl. CPC G06N 3/08; G06N 3/04

(57) ABSTRACT

Systems and processes for generating complementary acoustic models for performing automatic speech recognition system combination are provided. In one example process, a deep neural network can be trained using a set of training data. The trained deep neural network can be a deep neural network acoustic model. A Gaussian-mixture model can be linked to a hidden layer of the trained deep neural network such that any feature vector outputted from the hidden layer is received by the Gaussian-mixture model. The Gaussian-mixture model can be trained via a first portion of the trained deep neural network and using the set of training data. The first portion of the trained deep neural network can include an input layer of the deep neural network and the hidden layer. The first portion of the trained deep neural network and the trained Gaussian-mixture model can be a Deep Neural Network-Gaussian-Mixture Model (DNN-GMM) acoustic model.

### CROSS-REFERENCE TO RELATED APPLICATIONS

This application claims priority from U.S. Provisional Ser. No. 62/031,686, filed on Jul. 31, 2014, entitled EFFICIENT GENERATION OF COMPLEMENTARY ACOUSTIC MODELS FOR PERFORMING AUTOMATIC SPEECH RECOGNITION SYSTEM COMBINATION, and U.S. Provisional Ser. No. 62/039,332, filed on Aug. 19, 2014, entitled EFFICIENT GENERATION OF COMPLEMENTARY ACOUSTIC MODELS FOR PERFORMING AUTOMATIC SPEECH RECOGNITION SYSTEM COMBINATION, which are hereby incorporated by reference in their entirety for all purposes.

### FIELD

This relates generally to automatic speech recognition and, more specifically, to generating complementary acoustic models for performing automatic speech recognition system combination.

### BACKGROUND

State-of-the-art automatic speech recognition (ASR) systems can suffer from transcription errors. This can be true for all types of speech recognition systems, including systems based on traditional Gaussian-mixture model acoustic models as well as systems based on the recently more popular deep neural network acoustic models. One approach to minimizing transcription errors can include performing system combination. In system combination, a speech utterance can be transcribed with multiple ASR systems and the outputs obtained from the multiple ASR systems can be leveraged to arrive at a transcription having a lower error rate. However, performing system combination can involve higher computational cost. In addition, performing system combination can require complementary ASR systems having similar overall error rates. Conventionally, generating complementary ASR systems suitable for performing system combination may be an iterative, time-consuming, and inefficient process.

### SUMMARY

Systems and processes for generating complementary acoustic models for performing ASR system combination are provided. In one example process, a deep neural network can be trained using a set of training data. The deep neural network can comprise an input layer, an output layer, and a plurality of hidden layers disposed between the input layer and the output layer. Training the deep neural network can include determining, using the set of training data, a set of optimal weighting values of the deep neural network and storing the set of optimal weighting values in memory. A Gaussian-mixture model can be linked to a hidden layer of the trained deep neural network such that any feature vector outputted from the hidden layer is received by the Gaussian-mixture model. The Gaussian-mixture model can be trained via a first portion of the trained deep neural network and using the set of training data. The first portion of the trained deep neural network can include the input layer and the hidden layer. Training the Gaussian-mixture model can include determining, using the set of training data, a set of optimal parameter values of the Gaussian-mixture model and storing the set of optimal parameter values in memory.

### BRIEF DESCRIPTION OF THE DRAWINGS

FIG. 1 illustrates a process for generating complementary acoustic models for ASR system combination according to various examples.

FIG. 2 illustrates a deep neural network according to various examples.

FIG. 3 illustrates a hidden unit of a deep neural network according to various examples.

FIG. 4 illustrates a Gaussian-mixture model linked to a bottleneck layer of a deep neural network according to various examples.

FIG. 5 illustrates a system for generating complementary acoustic models for ASR system combination according to various examples.

FIG. 6 illustrates a system and environment for implementing ASR system combination of complementary acoustic models according to various examples.

FIG. 7 illustrates a user device for implementing aspects of ASR system combination of complementary acoustic models according to various examples.

FIG. 8 illustrates a functional block diagram of a computing device according to various examples.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

The present disclosure relates to systems and processes for generating complementary acoustic models for performing ASR system combination. In various examples described herein, a deep neural network can be trained using a set of training data. The trained deep neural network can be a deep neural network acoustic model. A Gaussian-mixture model can be linked to a hidden layer of the trained deep neural network such that any feature vector outputted from the hidden layer is received by the Gaussian-mixture model. In some examples, the Gaussian-mixture model can be linked to the hidden layer without severing the connections between the hidden layer and other layers of trained deep neural network. In some examples, the hidden layer can be a bottleneck layer. The Gaussian-mixture model can be trained via a first portion of the trained deep neural network and using the set of training data. The first portion of the trained deep neural network can include an input layer of the deep neural network and the hidden layer of the deep neural network. The first portion of the trained deep neural network and the trained Gaussian-mixture model can form a Deep Neural Network-Gaussian-Mixture Model (DNN-GMM) acoustic model.

By linking the Gaussian-mixture model to the hidden layer, two acoustic models sharing a common portion can be built. In particular, the deep neural network acoustic model and the DNN-GMM acoustic model can commonly share the first portion of the trained deep neural network. This can be advantageous for improving the computational efficiency of the two acoustic models. Further, the shared common portion can enable the two acoustic models to be built having complementary characteristics for purposes of performing ASR system combination. For example, the deep neural network acoustic model and the DNN-GMM acoustic model can have similar error rates, but produce different errors. Accordingly, the systems and processes disclosed herein can enable the efficient generation of complementary acoustic models for performing ASR system combination.

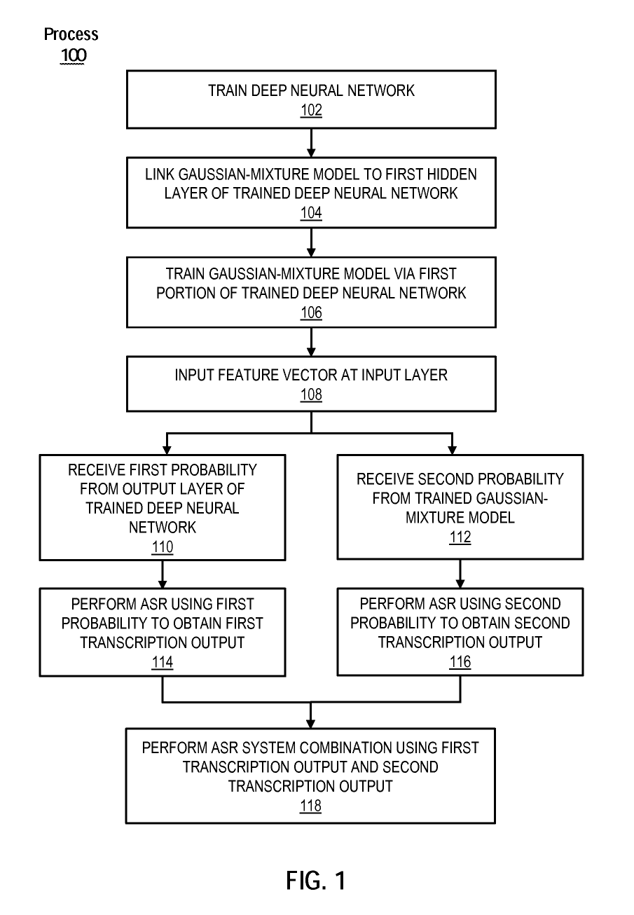

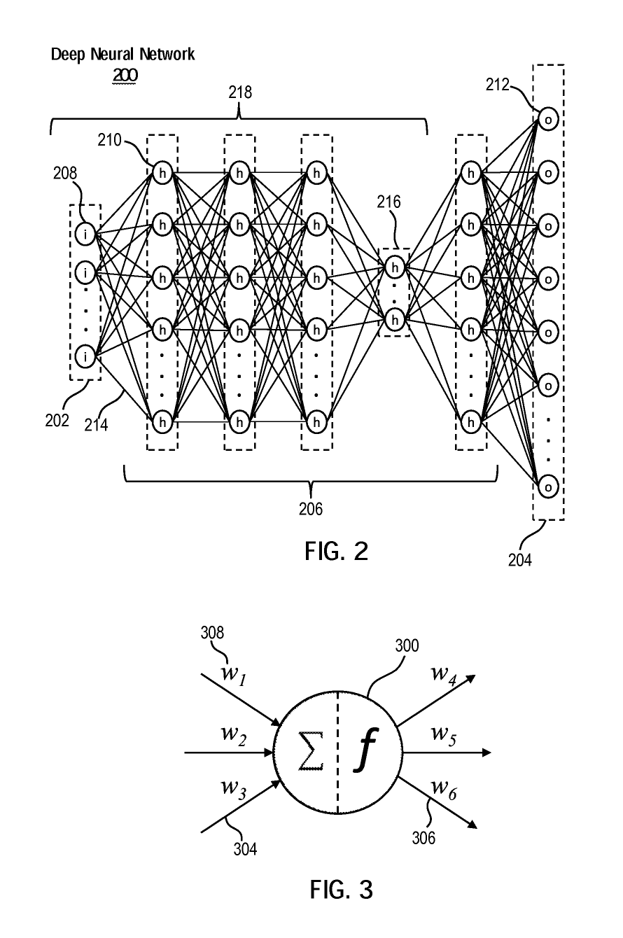

FIG. 1 illustrates exemplary process 100 for generating complementary acoustic models for performing ASR system combination. At block 102 of process 100, a deep neural network can be trained using a set of training data. For example, FIG. 2 depicts an exemplary deep neural network 200 that can be trained at block 102 using a set of training data. Deep neural network 200 can include multiple layers. In particular, deep neural network 200 can include input layer 202, output layer 204, and one or more hidden layers 206 disposed between input layer 202 and output layer 204. In this example, deep neural network 200 includes five hidden layers 206. It should be recognized however that in other examples, deep neural network 200 can include any number of hidden layers 206.

Each layer of deep neural network 200 can include multiple units. The units can be the basic computational elements of deep neural network 200 and can be referred to as dimensions, neurons, or nodes. As shown in FIG. 2, input layer 202 can include input units 208, hidden layers 206 can include hidden units 210, and output layer 204 can include output units 212. The units can be interconnected by connections 214. Specifically, connections 214 can connect the units of one layer to the units of a subsequent layer. Further, each connection 214 can be associated with a weighting value. For simplicity, the weighting values are not shown in FIG. 2.

FIG. 3 depicts an exemplary hidden unit 300 of a deep neural network (e.g., deep neural network 200). Hidden unit 300 can receive inputs from the units of a previous layer (not shown) via the connections (e.g., connection 304) depicted on one side of hidden unit 300. The connections providing input to hidden unit 300 can each be associated with a weighting value 308 (e.g., w₁, w₂, w₃), which can be applied to the input of the respective connection. The weighting values can determine the relative strength of the connections and thus the relative influence of the inputs on the output of hidden unit 300. Hidden unit 300 can be configured to compute the activation (denoted by the summation symbol Σ on hidden unit 300 of FIG. 3) of the unit, which can be, for example, the weighted sum of the inputs. Further, hidden unit 300 can be configured to derive an output of hidden unit 300 by applying an activation function (denoted by the symbol ƒ on hidden unit 300 of FIG. 3) to the computed activation. The activation function can be, for example, an identity function, a deterministic function (e.g., linear, sigmoid, threshold, or the like), or a stochastic function. It should be recognized that other suitable functions can be applicable.

The output from hidden unit 300 can be transmitted to the units of a subsequent layer (not shown) via the connections (e.g., connection 306) depicted on the other side of hidden unit 300. Each connection at the output of hidden unit 300 can be associated with a weighting value (e.g., w₄, w₅, w₆), which can be applied to the output of hidden unit 300 prior to being received as an input of a unit of a subsequent layer. As described in greater detail below, the weighting values of a deep neural network can be adjusted or modified during training to achieve an optimal set of weighting values in the trained deep neural network.

As shown in FIG. 2, deep neural network 200 can include bottleneck layer 216. Bottleneck layer 216 can be a hidden layer where the number of units in bottleneck layer 216 is less than the number of units in input layer 202. In other words, bottleneck layer 216 can have a fewer number of units than input layer 202. Thus, first portion 218 of deep neural network 200, which includes input layer 202 and bottleneck layer 216, can be configured to perform a dimensionality reduction on a feature vector that is inputted at input layer 202. Performing a dimensionality reduction can be desirable to reduce the time and computational cost associated with training Gaussian-mixture model 402 at block 106. In some examples, bottleneck layer 216 can have 20 to 50 units. In other examples, bottleneck layer 216 can have 30 to 40 units. Although bottleneck layer 216 is depicted as the fourth hidden layer from input layer 202, it should be recognized that bottleneck layer 216 can be any hidden layer and thus can be positioned anywhere between input layer 202 and output layer 204.

With reference back to block 102 of FIG. 1, the set of training data used to train the deep neural network can include a set of feature vectors. Each feature vector of the set of feature vectors can represent one or more segments of a speech signal. Example feature vectors can include frequency cepstrum coefficients, linear predictive cepstral coefficients, bark scale frequency cepstral coefficients, mel-frequency discrete wavelet coefficients, or the like. Further, the set of feature vectors can be labeled such that each feature vector is associated with a target phoneme or sequence of phonemes (e.g., di-phone, tri-phone, etc.).

With reference to FIG. 2, training deep neural network 200 can involve determining, using the set of training data, optimal weighting values of connections 214 within the deep neural network. Prior to training, initial values can be selected for the weighting values. During training, the weighting values can be adjusted in an iterative manner. After each iteration, a difference can be determined between the actual output produced by deep neural network 200 and the target output associated with the set of training data. The difference can be referred to as an error value. The weighting values of deep neural network 200 can then be adjusted based on the error value and according to a learning rate associated with deep neural network 200. In some examples, the weighting values can be adjusted via the use of back propagation to reduce the error value. Training can be determined to be complete when the error value is less than a predetermined threshold value for a predetermined minimum number of iterations. The weighting values of training deep neural network 200 can be referred to as the optimal weighting values of trained deep neural network 200. Block 102 can further include storing the trained deep neural network 200, including the optimal weighting values, in the memory of a device (e.g., a computing device implementing system 500, described below). In the present example, trained deep neural network 200 can be a deep neural network acoustic model. The deep neural network acoustic model can be configured to receive a feature vector representing one or more segments of a speech signal at input layer 202 and output, at output layer 204, a probability that the feature vector corresponds to a particular phoneme or sequence of phonemes.

It should be recognized that deep neural network 200 shown in FIG. 2 is illustrative of one example of a deep neural network and that other examples of a deep neural network can be used. For instance, a deep neural network having any number of units and any number of layers can be used. Further, in some examples, a deep neural network without a bottleneck layer can be used.

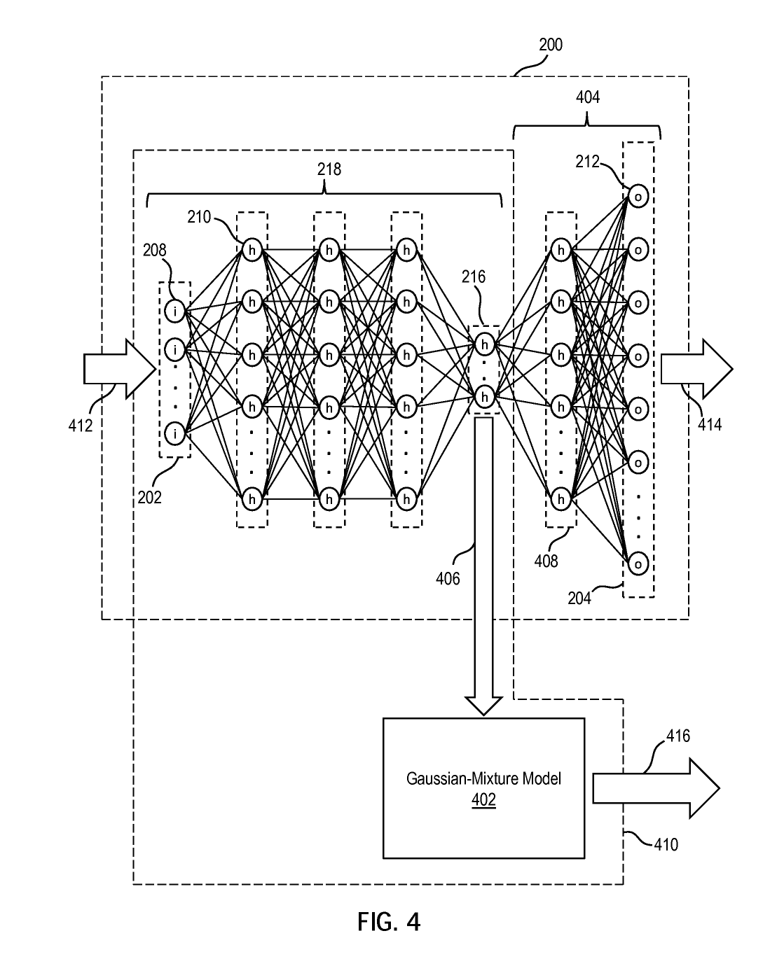

At block 104 of process 100 and with reference to FIG. 4, Gaussian-mixture model 402 can be linked to bottleneck layer 216 of trained deep neural network 200 such that any feature vector outputted from the bottleneck layer 216 is received by the Gaussian-mixture model 402. In particular, Gaussian-mixture model 402 can be linked to bottleneck layer 216 without severing the connections between bottleneck layer 216 and other layers of trained deep neural network 200. For example, as shown in FIG. 4, the connections from the units of bottleneck layer 216 to the units of hidden layer 408 are not severed during process 100, thereby enabling trained deep neural network 200 to continue functioning as a deep neural network acoustic model despite being linked to Gaussian-mixture model 402. Accordingly, feature vectors outputted from bottleneck layer 216 can be sent to second portion 404 of trained deep neural network 200 via connections as well as to Gaussian-mixture model 402 via link 406.

Linking Gaussian-mixture model 402 to bottleneck layer 216 at block 104 without severing any connections associated with bottleneck layer 216 can be advantageous for increasing the computational efficiency associated with the resultant acoustic models. In particular, first portion 218 of trained deep neural network 200 can be commonly shared between Gaussian-mixture model 402 and second portion 404 of trained deep neural network 200. Thus, the resultant acoustic models (e.g., deep neural network acoustic model and DNN-GMM acoustic model 410) can share the computational cost associated with first portion 218, thereby reducing computational time and increasing computational efficiency.

It should be recognized that Gaussian-mixture model 402 can be linked to any hidden layer of trained deep neural network 200. The hidden layer to which Gaussian-mixture model 402 is linked can delineate the boundary between first portion 218 and second portion 404 of trained deep neural network 200. In this example, first portion 218 can include input layer 202, three hidden layers, and bottleneck layer 216 while second portion 404 can include hidden layer 408 and output layer 204. It should be recognized that, in other examples, first portion 218 and second portion 404 can each include fewer or additional hidden layers.

Although Gaussian-mixture model 402 can be linked to any hidden layer of trained deep neural network 200, linking Gaussian-mixture model 402 to bottleneck layer 216 can be advantageous for training Gaussian-mixture model 402 efficiently. In particular, bottleneck layer 216 can enable the feature vectors outputted from bottleneck layer 216 to have significantly fewer dimensions than the feature vectors inputted at input layer 202. This can reduce the number of parameters that need to be evaluated when training Gaussian-mixture model 402 at block 106, which reduces computational cost, training time, and the amount of training data required.

At block 106 of process 100, Gaussian-mixture model 402 can be trained, via first portion 218 of trained deep neural network 200, using a set of training data. In some examples, the same set of training data used to train deep neural network 200 can be used to train Gaussian-mixture model 402 via first portion 218. The set of training data can be inputted to input layer 202 of first portion 218 and Gaussian-mixture model 402 can be trained using the corresponding feature vectors outputted from bottleneck layer 216.

Gaussian-mixture model 402 can include adjustable parameter values such as means and covariance associated with each phoneme or sequence of phonemes. Training Gaussian-mixture model 402 at block 106 can include determining a set of optimal parameter values for Gaussian-mixture model 402. Starting from initial estimates, the adjustable parameter values can be iteratively modified based on the set of training data and using re-estimation procedures such as the Expectation Maximization (EM) and log-likelihood gradient ascent algorithms to arrive at a set of intermediate parameter values. In some examples, training Gaussian-mixture model 402 can further include performing discriminative training. The set of intermediate parameters values can be adjusted during discriminative training to minimize the error rate of Gaussian-mixture model 402, thereby arriving at the set of optimal parameter values. In some examples, the set of optimal parameter values can be stored in the memory of a device (e.g., a computing device implementing system 500, described below).

First portion 218 of trained deep neural network 200 and trained Gaussian-mixture model 402 can form DNN-GMM acoustic model 410. DNN-GMM acoustic model 410 can be configured to receive at input layer 202 a feature vector representing one or more segments of a speech signal and output, at trained Gaussian-mixture model 402, a probability that the feature vector corresponds to a particular phoneme or sequence of phonemes. In the present example, DNN-GMM acoustic model 410 can also be referred to as a bottleneck-Gaussian-mixture model.

As shown in FIG. 4, two acoustic models can be generated by process 100: the deep neural network acoustic model (e.g., trained deep neural network 200) and DNN-GMM acoustic model 410. The two acoustic models can be configured to receive a feature vector representing one or more segments of a speech signal at input layer 202. In response to receiving at input layer 202 the feature vector representing one or more segments of a speech signal, a first probability can be outputted from the output layer 204 of trained deep neural network 200 and a second probability can be outputted from trained Gaussian-mixture model 402. The first probability and the second probability can each be the probability that the feature vector corresponds to a particular phoneme or sequence of phonemes. In some examples, the first probability can be different from the second probability.

The deep neural network acoustic model (e.g., trained deep neural network 200) and DNN-GMM acoustic model 410 can have complementary characteristics that make the two acoustic models suitable for performing ASR system combination. For example, the deep neural network acoustic model and DNN-GMM acoustic model 410 can have similar error rates and yet produce different errors. This can be because the two acoustic models are generated using the same training data, share a common front end (e.g., first portion 218 of trained deep neural network 200), but have different back ends (e.g., second portion 404 of trained deep neural network 200 and trained Gaussian-mixture model 402).

In various examples, the relative difference between the error rate of the deep neural network acoustic model and the error rate of DNN-GMM acoustic model 410 can be less than 20 percent, less than 15 percent, less than 10 percent, or less than 5 percent. The relative difference can refer to the percentage difference between the error rate of the deep neural network acoustic model and the error rate of DNN-GMM acoustic model 410. In other words, if the error rate of the deep neural network acoustic model is 9 percent and the error rate of DNN-GMM acoustic model 410 is 9.9 percent, then the relative difference between the error rate of the deep neural network acoustic model and the error rate of DNN-GMM acoustic model 410 would be 10 percent.

Further, in various examples, the error rate of DNN-GMM acoustic model 410 with respect to the deep neural network acoustic model can be greater than 0.5 percent, greater than 1 percent, greater than 2 percent, or greater than 3 percent. The error rate of DNN-GMM acoustic model 410 with respect to the deep neural network acoustic model can refer to the error rate of DNN-GMM acoustic model 410 when the output of the deep neural network acoustic model is used as a reference for comparison. In other words, if DNN-GMM acoustic model 410 produced a different output than the deep neural network acoustic model in 1 out of 100 occasions while producing an equivalent output as the deep neural network acoustic model in 99 out of 100 occasions, then the error rate of DNN-GMM acoustic model 410 with respect to the deep neural network acoustic model would be 1 percent.

It should be recognized that various aspects of deep neural network 200 and Gaussian-mixture model 402 can be modified to optimize the performance of the resultant deep neural network acoustic model and the hybrid model. For example, the number of hidden layers and the number of units in each hidden layer can vary. Further, the number of units in bottleneck layer 216 and thus the number of parameters in Gaussian-mixture model 402 can vary. However, as described above, it can be desirable to generate complementary acoustic models that are suitable for performing ASR system combination. Therefore, in some examples, the number of hidden layers in trained deep neural network 200 and the number of parameters in the trained Gaussian-mixture model 402 can be such that the relative difference between the error rate of the deep neural network acoustic model and the error rate of DNN-GMM acoustic model 410 is less than 10 percent (or less than 20, 15, or 5 percent) and the error rate of DNN-GMM acoustic model 410 with respect to the deep neural network acoustic model is greater than 1 percent (or greater than 0.5, 2, or 3 percent). Further, for real-time ASR, it can be desirable for the two acoustic models to have similar computational times.

Blocks 108 through 118 of process 100 describe using the deep neural network acoustic model (e.g., trained deep neural network 200) and DNN-GMM acoustic model 410 to perform ASR and ASR system combination. At block 108 of process 100, a feature vector representing one or more segments of a speech signal can be inputted (as depicted by arrow 412 of FIG. 4) at input layer 202. For example, the feature vector can include frequency cepstrum coefficients, linear predictive cepstral coefficients, bark scale frequency cepstral coefficients, mel-frequency discrete wavelet coefficients, or the like.

At block 110 of process 100, a first probability that the feature vector corresponds to a particular phoneme or sequence of phonemes can be received from output layer 204. In particular, the feature vector inputted at block 108 can be propagated through first portion 218 of trained deep neural network 200 to produce an intermediate feature vector at the output of bottleneck layer 216. The intermediate feature vector can be propagated through second portion 404 of trained deep neural network 200 to output (as depicted by arrow 414 of FIG. 4) the first probability at output layer 204.

At block 112 of process 100, a second probability that the feature vector corresponds to the particular phoneme or sequence of phonemes can be received from trained Gaussian-mixture model. In particular, the intermediate feature vector at the output of bottleneck layer 216 can be received and evaluated by trained Gaussian-mixture model 402 to output (as depicted by arrow 416 of FIG. 4) the second probability from trained Gaussian-mixture model 402. In some examples, the second probability can be different from the first probability.

At block 114 of process 100, ASR can be performed using the first probability received at block 110 to obtain a first transcription output. For example, ASR can be performed using one or more language models. The first transcription output can be generated using the one or more language models and based at least in part on the first probability and the phoneme or sequence of phonemes associated with the first probability. The first transcription output can be a word, a portion of a word, a sequence of words, a word lattice, or a word confusion network.

At block 116 of process 100, ASR can be performed using the second probability received at block 112 to obtain a second transcription output. Block 116 can be similar to block 114 except that ASR is performed using the second probability rather than the first probability. The second transcription output can be generated using one or more language models and based at least in part on the second probability and the phoneme or sequence of phonemes associated with the second probability. The second transcription output can be a word, a portion of a word, a sequence of words, a word lattice, or a word confusion network. In some examples, the second transcription output can be different from the first transcription output.

It should be recognized that in some examples, ASR can be performed at block 114 using the second probability in addition to the first probability. Similarly, in some examples, ASR can be performed at block 116 using the first probability in addition to the second probability. In particular, in some examples, ASR can be performing at block 114 using both the first probability and the second probability to obtain the first transcription output and ASR can be performed at block 116 using the second probability and not the first probability to obtain the second transcription output. In other examples, ASR can be performed at block 114 using the first probability and not the second probability to obtain the first transcription output and ASR can be performed at block 116 using both the first probability and the second probability to obtain the second transcription output.

At block 118 of process 100, ASR system combination can be performed using the first transcription output and the second transcription output. Examples of ASR system combination approaches can include cross-adaptation, recognition output voting error reduction (ROVER), confusion network combination, and the like. In some examples, ASR system combination can be performed to generate a third transcription output based at least in part on the first transcription output and the second transcription output.

Although process 100 is described above with reference to blocks 102 through 118, it should be appreciated that in some cases, one or more blocks of process 100 can be optional and additional blocks can also be performed. For instance, in some examples, blocks 108 through 118 can be optional. In other examples, blocks 102 through 106 can be optional. Further, it should be recognized that although blocks 102 through 118 are depicted in a particular order, these blocks may be performed in any order and some blocks may be performed simultaneously. For example, blocks 110 can be performed before, after, or simultaneously with block 112. Similarly, in some examples, block 114 can be performed before, after, or simultaneously with block 116.

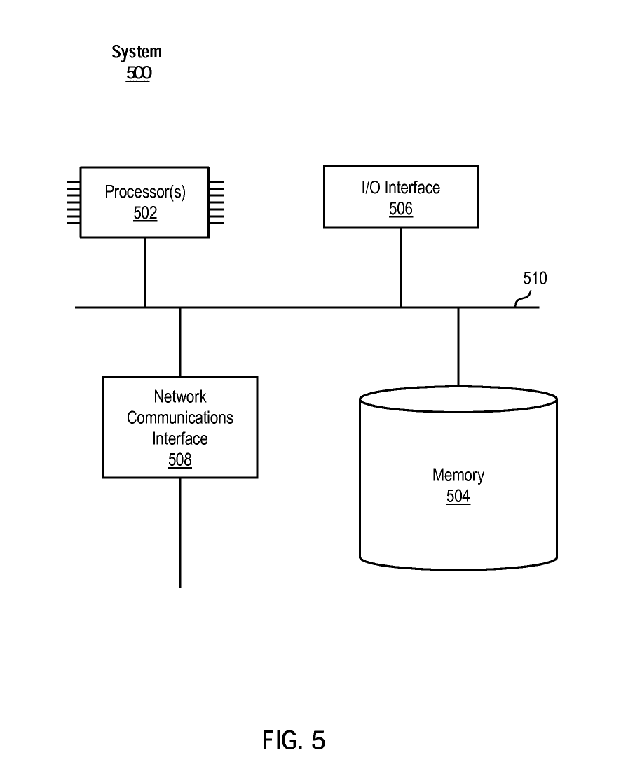

FIG. 5 is a block diagram depicting exemplary system 500 for generating complementary acoustic models for performing ASR system combination. System 500 can be implemented on any computing device or network of computing devices. The computing device can include any electronic device such as a server system, mobile phone, tablet computer, portable media player, desktop computer, laptop computer, PDA, television, television set-top box, wearable electronic device, or the like. System 500 can include one or more processors 502, memory 504, input/output (I/O) interface 506, and network communications interface 508. These components can communicate with one another over one or more communication buses or signal lines 510.

In some examples, one or more processors 502 can include one or more microprocessors, such as a single core or multi-core microprocessor. In some examples, one or more processors 502 can include one or more general purpose processors. In some examples, one or more processors 502 can include one or more special purpose processors. In some examples, one or more processors 502 can include one or more personal computers, mobile devices, handheld computers, tablet computers, or one of a wide variety of hardware platforms that contain one or more processing units and run on various operating systems.

Memory 504 can include high-speed random access memory, such as DRAM, SRAM, DDR RAM, or other random access solid state memory devices. In addition, memory 504 can include non-volatile memory, such as one or more magnetic disk storage devices, optical disk storage devices, flash memory devices, or other non-volatile solid state storage devices. In some examples, memory 504 can include one or more storage devices remotely located from processors 502. Memory 504, or alternately the non-volatile memory device(s) within the memory 504, can comprise non-transitory computer-readable storage medium. The non-transitory computer-readable storage medium of memory 504 can store programs, modules, instructions, and/or data structures. In some examples, the instructions can include instructions for performing various aspects of process 100 described above with reference to FIG. 1. In some examples, the data structures can include the optimal weighting values of trained deep neural network 200 and the optimal parameter values of trained Gaussian-mixture model 402, described above with reference to FIG. 4. In some examples, the data structures can include trained deep neural network 200 and trained Gaussian-mixture model 402. One or more processors 502 can be operable to execute these programs, modules, and/or instructions of the non-transitory computer-readable storage medium of memory 504 and reads/writes from/to the data structures of the non-transitory computer-readable storage medium of memory 504. In the context of this disclosure, a “non-transitory computer-readable storage medium” can be any medium that can contain or store the program for use by or in connection with a processor, instruction execution system, apparatus, or device.

In some examples, I/O interface 506 can couple input/output devices, such as displays, keyboards, touch screens, speakers, and microphones to system 500. I/O interface 506 can receive user inputs (e.g., voice inputs, keyboard inputs, touch inputs, etc.) and process them accordingly. Further, I/O interface 506 can present outputs (e.g., sounds, images, text, etc.) to the user.

In some examples, network communications interface 508 can include wired communication port(s) and/or wireless transmission and reception circuitry. The wired communication port(s) can receive and send communication signals via one or more wired interfaces (e.g., Ethernet, Universal Serial Bus (USB), FIREWIRE, etc.). The wireless circuitry can receive and send RF signals and/or optical signals from/to communication networks and other communication devices. The wireless communications can use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 508 can enable communication between system 500 and other devices via networks, such as the Internet, an intranet and/or a wireless network, such as a cellular telephone network, a wireless local area network (LAN), and/or a metropolitan area network (MAN).

In some examples, memory 504 can include an operating system (e.g., Darwin, RTXC, LINUX, UNIX, OS X, WINDOWS, or an embedded operating system such as VxWorks). The operating system can include various software components and/or drivers for controlling and managing general system tasks (e.g., memory management, storage device control, power management, etc.) and facilitates communications between various hardware, firmware, and software components.

In some examples, system 500 can be implemented on a standalone computing device. In some examples, system 500 can be distributed across multiple computing devices. In some examples, some of the modules and functions of system 500 can be divided into a server portion and a client portion, where the client portion resides on a user device and communicates with the server portion residing on a server device through one or more networks. It should be noted that system 500 is only one example and that system 500 can have more or fewer components than shown, can combine two or more components, or can have a different configuration or arrangement of the components. The various components shown in FIG. 5 can be implemented in hardware, software, firmware, including one or more signal processing and/or application-specific integrated circuits, or a combination of thereof.

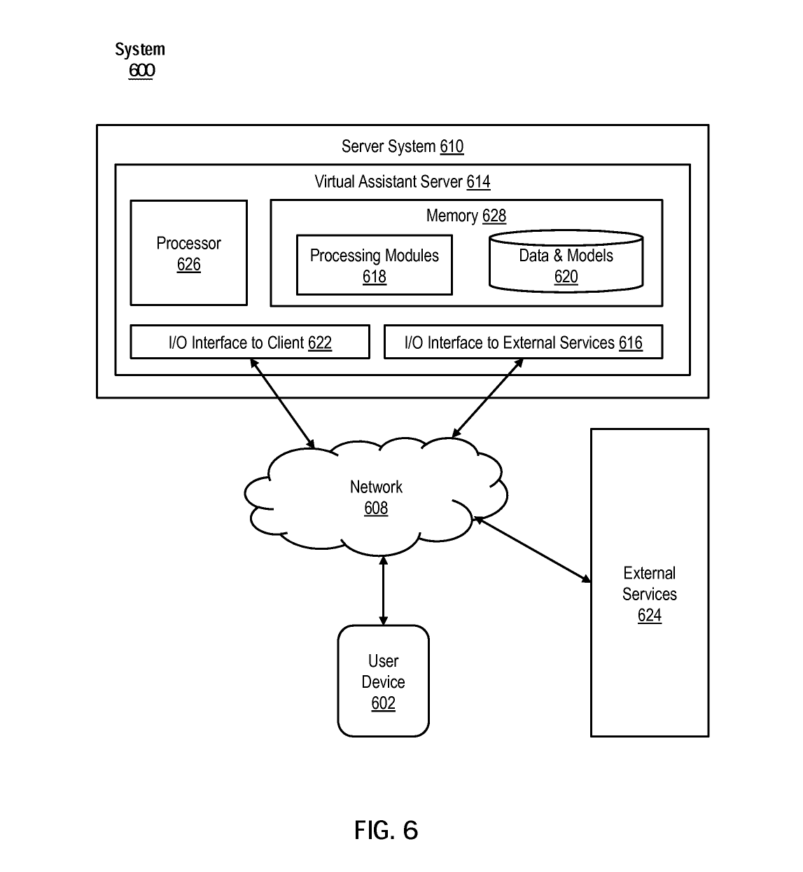

FIG. 6 illustrates exemplary system 600 for performing ASR system combination using complementary acoustic models. In some examples, system 600 can implement a virtual assistant. The terms “virtual assistant,” “digital assistant,” “intelligent automated assistant,” or “automatic digital assistant,” can refer to any information processing system (e.g., system 600) that can interpret natural language input in spoken and/or textual form to infer user intent and perform actions based on the inferred user intent.

The virtual assistant can be capable of processing natural language input. For example, the virtual assistant can be capable of performing ASR (e.g., blocks 108 through 116 of process 100, described above) on a spoken input in order to obtain a textual representation of the spoken input. The ASR can be performed using complementary acoustic models (e.g., the deep neural network acoustic model and DNN-GMM acoustic model 410, described above). Further, the virtual assistant can be capable of performing ASR system combination (blocks 118 of process 100, described above). The textual representation can be analyzed to infer user intent. The virtual assistant can then act on the inferred user intent by performing one or more of the following: identifying a task flow with steps and parameters designed to accomplish the inferred user intent; inputting specific requirements from the inferred user intent into the task flow; executing the task flow by invoking programs, methods, services, application programming interfaces (APIs), or the like; and generating output responses to the user in an audible (e.g., speech) and/or visual form.

An example of a virtual assistant is described in Applicants' U.S. Utility application Ser. No. 12/987,982 for “Intelligent Automated Assistant,” filed Jan. 10, 2011, the entire disclosure of which is incorporated herein by reference.

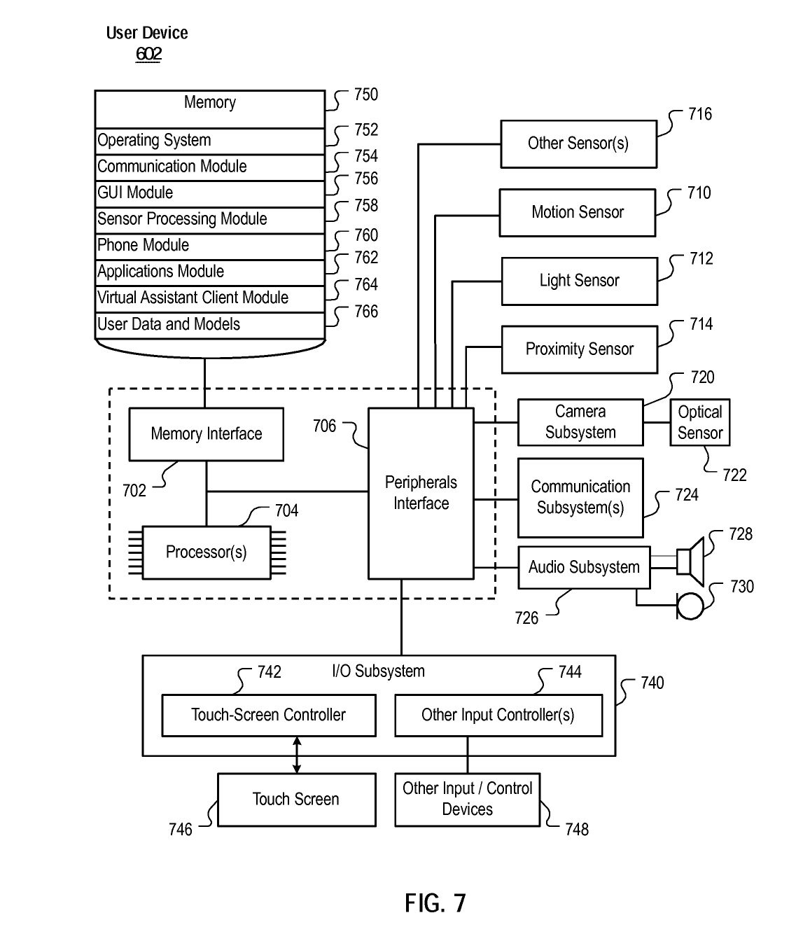

As shown in FIG. 6, in some examples, a virtual assistant can be implemented according to a client-server model. The virtual assistant can include a client-side portion executed on user device 602, and a server-side portion executed on server system 610. User device 602 can include any electronic device, such as a mobile phone, tablet computer, portable media player, desktop computer, laptop computer, PDA, television, television set-top box, wearable electronic device, or the like, and can communicate with server system 610 through one or more networks 608, which can include the Internet, an intranet, or any other wired or wireless public or private network. A detailed description of user device 602 is provided below with reference to FIG. 7. The client-side portion executed on user device 602 can provide client-side functionalities, such as user-facing input and output processing and communications with server system 610. Server system 610 can provide server-side functionalities for any number of clients residing on a respective user device 602.

Server system 610 can include one or more virtual assistant servers 614. As shown in FIG. 6, virtual assistant server 614 includes memory 628, one or more processors 626, client-facing I/O interface 622, and I/O interface to external services 616. The various components of virtual assistant server 614 can be coupled together by one or more communication buses or signal lines. Memory 628, or the computer-readable storage media of memory 628, can include one or more processing modules 618 and data and models 620. The one or more processing modules 618 can include various programs and instructions. The one or more processors 626 can execute the programs and instructions of the one or more processing modules 628 and read to or write from data and models 620.

In some examples, the one or more processing modules 618 can include various programs and instructions for performing ASR using complementary acoustic models (e.g., blocks 108 through 116 of process 100, described above) and ASR system combination (e.g., block 118 of process 100, described above). In some examples, the one or more processing modules 618 can include a speech-to-text (e.g., ASR) processing module, a natural language processing module, a task flow processing module, and a service processing module. The speech-to-text processing module can include instructions for transcribing a speech utterance in an audio input. In some examples, the instructions for transcribing a speech utterance can include instructions for performing ASR using complementary acoustic models (e.g., blocks 108 through 116 of process 100, described above). In some examples, the instructions for transcribing a speech utterance can further include instructions for performing ASR system combination (e.g., block 118 of process 100, described above). The natural language processing module can include instructions for inferring user intent from the transcribed speech utterance. The task flow processing module and the service processing module can include instructions for identifying a task flow to accomplish the inferred user intent, inputting specific requirements from the inferred user intent into the task flow, executing the task flow, and outputting relevant responses to the speech utterance. For example, the task flow processing module and the service processing module can include instructions for performing one or more tasks associated with the natural language input. Data and models 620 can include various user data and models that can be accessed or referenced when performing ASR system combination using complementary acoustic models. For example, data and models 620 can include acoustic models (e.g., deep neural network acoustic model and DNN-GMM acoustic model 410, described above), speech models, language models, task flow models, and service models.

In some examples, virtual assistant server 614 can communicate with external services 624, such as telephony services, calendar services, information services, messaging services, navigation services, and the like, through network(s) 608 for task completion or information acquisition. The I/O interface to external services 616 can facilitate such communications.

Server system 610 can be implemented on one or more standalone data processing devices or a distributed network of computers. In some examples, server system 610 can employ various virtual devices and/or services of third-party service providers (e.g., third-party cloud service providers) to provide the underlying computing resources and/or infrastructure resources of server system 610.

Although the functionality of the virtual assistant is shown in FIG. 6 as including both a client-side portion and a server-side portion, in some examples, the functions of the virtual assistant can be implemented as a standalone application installed on a user device (e.g., user device 602). In addition, the division of functionalities between the client and server portions of the virtual assistant can vary in different examples. For instance, in some examples, one or more processing modules 618 and data and models 620 can be stored in the memory of user device 602 to enable user device 602 to perform a greater proportion or all of the functionalities associated with the virtual assistant. In other examples, the client portion that is executed on user device 602 can be a thin-client that provides only user-facing input and output processing functions, and delegates all other functionalities of the virtual assistant to a backend server.

FIG. 7 is a block diagram of user device 602 according to various examples. As shown, user device 602 can include memory interface 702, one or more processors 704, and peripherals interface 706. The various components in user device 602 can be coupled together by one or more communication buses or signal lines. User device 602 can further include various sensors, subsystems, and peripheral devices that are coupled to the peripherals interface 706. The sensors, subsystems, and peripheral devices gather information and/or facilitate various functionalities of user device 602.

For example, user device 602 can include motion sensor 710, light sensor 712, and proximity sensor 714 coupled to peripherals interface 706 to facilitate orientation, light, and proximity sensing functions. One or more other sensors 716, such as a positioning system (e.g., a GPS receiver), a temperature sensor, a biometric sensor, a gyroscope, a compass, an accelerometer, and the like, can also be connected to peripherals interface 706 to facilitate related functionalities.

In some examples, camera subsystem 720 and optical sensor 722 can be utilized to facilitate camera functions, such as taking photographs and recording video clips. Communication functions can be facilitated through one or more wired and/or wireless communication subsystems 724, which can include various communication ports, radio frequency receivers and transmitters, and/or optical (e.g., infrared) receivers and transmitters. Audio subsystem 726 can be coupled to speakers 728 and microphone 730 to facilitate audio-enabled functions, such as voice recognition, music recognition, voice replication, digital recording, and telephony functions.

In some examples, user device 602 can further include an I/O subsystem 740 coupled to peripherals interface 706. I/O subsystem 740 can include a touch-screen controller 742 and/or other input controller(s) 744. Touch-screen controller 742 can be coupled to a touch screen 746. Touch screen 746 and the touch-screen controller 742 can, for example, detect contact and movement or break thereof using any of a plurality of touch-sensitivity technologies, such as capacitive, resistive, infrared, surface acoustic wave technologies, proximity sensor arrays, and the like. Other input controller(s) 744 can be coupled to other input/control devices 748, such as one or more buttons, rocker switches, a keyboard, a thumb-wheel, an infrared port, a USB port, and/or a pointer device such as a stylus.

In some examples, user device 602 can further include memory interface 702 coupled to memory 750. Memory 750 can be similar or identical to memory 504, described above. In some examples, a non-transitory computer-readable storage medium of memory 750 can be used to store instructions (e.g., for performing various aspects of process 100, described above) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing various aspects of process 100, described above) can be stored on a non-transitory computer-readable storage medium of server system 610, or can be divided between the non-transitory computer-readable storage medium of memory 750 and the non-transitory computer-readable storage medium of server system 610.

In some examples, memory 750 can store an operating system 752, communication module 754, graphical user interface module 756, sensor processing module 758, phone module 760, and applications module 762. Operating system 752 can include instructions for handling basic system services and for performing hardware dependent tasks. Communication module 754 can facilitate communicating with one or more additional devices, one or more computers, and/or one or more servers. Graphical user interface module 756 can facilitate graphical user interface processing. Sensor processing module 758 can facilitate sensor related processing and functions. Phone module 760 can facilitate phone-related processes and functions. Applications module 762 can facilitate various functionalities of user applications, such as electronic messaging, web browsing, media processing, navigation, imaging, and/or other processes and functions.

As described herein, memory 750 can also store client-side virtual assistant instructions (e.g., in a virtual assistant client module 764) and various user data and models 766 to provide the client-side functionalities of the virtual assistant. In some examples, the virtual assistant client module 764 can include modules, instructions, and programs for performing various aspects of process 100, described above. In other examples, the instructions for performing various aspects of process 100 can be stored in a separate module (e.g., an ASR module) in memory 750. User data and models 766 can include user-specific vocabulary data, preference data, and/or other data such as the user's electronic address book, to-do lists, shopping lists, and the like. In addition, user data and models 766 can include acoustic models (e.g., the deep neural network acoustic model and DNN-GMM acoustic model 410, described above), speech models, language models, task flow models, and service models.

In various examples, virtual assistant client module 764 can include instructions for accepting natural language input (e.g., speech and/or text), touch input, and/or gestural input through various user interfaces (e.g., I/O subsystem 740, audio subsystem 726, or the like) of user device 602. Virtual assistant client module 764 can also include instructions for providing output in audio (e.g., speech and/or music output), visual, and/or tactile forms. For example, output can be provided as voice, music, sound, alerts, text messages, menus, graphics, videos, animations, vibrations, and/or combinations of two or more of the above. During operation, user device 602 can communicate with the virtual assistant server using communication subsystems 724 to perform the functionalities associated with the virtual assistant.

In various examples, memory 750 can include additional instructions or fewer instructions. Furthermore, various functions of user device 602 can be implemented in hardware and/or in firmware, including in one or more signal processing and/or application specific integrated circuits.

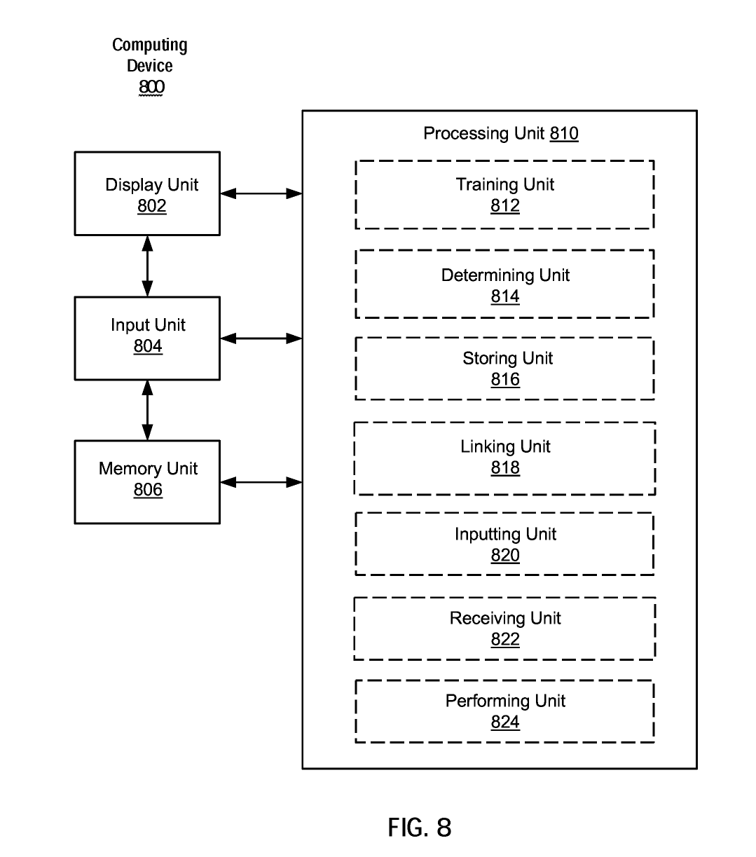

FIG. 8 shows a functional block diagram of a computing device 800 configured in accordance with the principles of the various described examples. The functional blocks of the device can be optionally implemented by hardware, software, or a combination of hardware and software to carry out the principles of the various described examples. It is understood by persons of skill in the art that the functional blocks described in FIG. 8 can be optionally combined, or separated into sub-blocks to implement the principles of the various described examples. Therefore, the description herein optionally supports any possible combination, separation, or further definition of the functional blocks described herein.

As shown in FIG. 8, computing device 800 can include display unit 802 configured to display a user interface, input unit 804 configured to receive user input, and memory unit 806 configured to store data. In some examples, input unit 804 can be configured to receive a speech utterance from a user and transmit a speech signal representing the speech utterance to processing unit 810. Computing device 800 can further include processing unit 810 coupled to display unit 802, input unit 804, and memory unit 806. In some examples, processing unit 810 can include training unit 812, determining unit 814, storing unit 816, linking unit 818, inputting unit 820, receiving unit 822, and performing unit 824.

Processing unit 810 can be configured to train (e.g., using training unit 812) a deep neural network using a set of training data. The deep neural network can comprise an input layer, an output layer, and a plurality of hidden layers disposed between the input layer and the output layer. In some examples, training the deep neural network can include determining (e.g., using determining unit 814) a set of optimal weighting values of the deep neural network using the set of training data and storing (e.g., using storing unit 816) the set of optimal weighting values in memory (e.g., memory unit 806). Processing unit 810 can be configured to link (e.g., using linking unit 818) a Gaussian-mixture model to a hidden layer of the trained deep neural network such that any feature vector outputted from the hidden layer is received by the Gaussian-mixture model. Processing unit 810 can be configured to train (e.g., using training unit 812) the Gaussian-mixture model via a first portion of the trained deep neural network and using the set of training data. The first portion of the trained deep neural network can include the input layer and the hidden layer. In some examples, training the Gaussian-mixture model can include determining (e.g., using determining unit 814) a set of optimal parameter values of the Gaussian-mixture model using the set of training data and storing (e.g., using storing unit 816) the set of optimal parameter values in memory (e.g., memory unit 806).

In some examples, the hidden layer can be a bottleneck layer and a number of units of the bottleneck layer can be less than a number of units of the input layer. In some examples, the bottleneck layer has 20 to 50 units. In other examples, the bottleneck layer has 30 to 40 units. In some examples, the first portion of the trained deep neural network can be configured to perform a dimensionality reduction on a feature vector that is inputted at the input layer.

In some examples, linking the Gaussian-mixture model to the hidden layer can be performed without severing a connection from the hidden layer to another layer of the trained deep neural network. In some examples, any feature vector outputted from the hidden layer can be received by a second portion of the trained deep neural network. The second portion of the trained deep neural network can include the output layer. In some examples, the second portion of the trained deep neural network can further include a second hidden layer.

In some examples, in response to receiving at the input layer a feature vector representing one or more segments of a speech signal, a first probability that the feature vector corresponds to a particular phoneme or sequence of phonemes can be outputted from the output layer and a second probability that the feature vector corresponds to the particular phoneme or sequence of phonemes can be outputted from the trained Gaussian-mixture model.

In some examples, processing unit 810 can be configured to input (e.g., using inputting unit 820) at the input layer a feature vector representing one or more segments of a speech signal. The speech signal can be received from input unit 804. Processing unit 810 can be configured to receive (e.g., using receiving unit 822) a first probability that the feature vector corresponds to a particular phoneme or sequence of phonemes from the output layer. Processing unit 810 can be configured to receive (e.g., using receiving unit 822) a second probability that the feature vector corresponds to the particular phoneme or sequence of phonemes from the trained Gaussian-mixture model.

In some examples, processing unit 810 can be configured to perform (e.g., using performing unit 824) ASR using the first probability to obtain a first transcription output. Processing unit 810 can be configured to perform (e.g., using performing unit 824) ASR using the second probability to obtain a second transcription output. Processing unit 810 can be configured to perform (e.g., using performing unit 824) ASR system combination using the first transcription output and the second transcription output. In some examples, a third transcription output can be generated based on the first transcription output and the second transcription output by performing ASR system combination.

In some examples, the trained deep neural network can be a deep neural network acoustic model. In some examples, the first portion of the trained deep neural network and the trained Gaussian-mixture model can form a DNN-GMM acoustic model.

In some examples, a relative difference between an error rate of the deep neural network acoustic model and an error rate of the DNN-GMM acoustic model can be less than 10 percent. In some examples, an error rate of the DNN-GMM acoustic model with respect to the deep neural network acoustic model can be greater than 1 percent.

In some examples, a number of hidden layers in the trained deep neural network and a number of parameters of the trained Gaussian-mixture model can be such that a relative difference between an error rate of the deep neural network acoustic model and an error rate of the DNN-GMM acoustic model is less than 10 percent and an error rate of the DNN-GMM acoustic model with respect to the deep neural network acoustic model is greater than 1 percent.

In some examples, the set of training data can include a set of feature vectors. The set of feature vectors can be labeled such that each feature vector of the set of feature vectors is associated with a target phoneme or sequence of phonemes. In some examples, each feature vector of the set of feature vectors can represent one or more segments of a speech signal.

Although examples have been fully described with reference to the accompanying drawings, it is to be noted that various changes and modifications will become apparent to those skilled in the art. Such changes and modifications are to be understood as being included within the scope of the various examples as defined by the appended claims.

What is claimed is:

1. A method for generating complementary acoustic models for performing automatic speech recognition system combination, the method comprising:
at a device with a processor and memory storing instructions for execution by the processor:
training a deep neural network using a set of training data, wherein the deep neural network comprises an input layer, an output layer, and a plurality of hidden layers disposed between the input layer and the output layer, wherein training the deep neural network comprises:
determining, using the set of training data, a set of optimal weighting values of the deep neural network; and
storing the set of optimal weighting values in the memory;
linking a Gaussian-mixture model to a hidden layer of the trained deep neural network such that any feature vector outputted from the hidden layer is received by the Gaussian-mixture model; and
training the Gaussian-mixture model via a first portion of the trained deep neural network and using the set of training data, wherein the first portion of the trained deep neural network includes the input layer and the hidden layer, and wherein training the Gaussian-mixture model comprises:
determining, using the set of training data, a set of optimal parameter values of the Gaussian-mixture model; and
storing the set of optimal parameter values in the memory.

2. The method of claim 1, wherein the hidden layer is a bottleneck layer, and wherein a number of units of the bottleneck layer is less than a number of units of the input layer.

3. The method of claim 2, wherein the bottleneck layer has 20 to 50 units.

4. The method of claim 2, wherein the bottleneck layer has 30 to 40 units.

5. The method of claim 1, wherein the first portion of the trained deep neural network is configured to perform a dimensionality reduction on a feature vector that is inputted at the input layer.

6. The method of claim 1, wherein linking the Gaussian-mixture model to the hidden layer is performed without severing a connection from the hidden layer to another layer of the trained deep neural network.

7. The method of claim 1, wherein any feature vector outputted from the hidden layer is received by a second portion of the trained deep neural network, the second portion of the trained deep neural network comprising the output layer.

8. The method of claim 7, wherein the second portion of the trained deep neural network further comprises a second hidden layer.

9. The method of claim 1, wherein in response to receiving at the input layer a feature vector representing one or more segments of a speech signal:
a first probability that the feature vector corresponds to a particular phoneme or sequence of phonemes is outputted from the output layer; and
a second probability that the feature vector corresponds to the particular phoneme or sequence of phonemes is outputted from the trained Gaussian-mixture model.

10. The method of claim 1, further comprising:
inputting at the input layer a feature vector representing one or more segments of a speech signal;
receiving a first probability that the feature vector corresponds to a particular phoneme or sequence of phonemes from the output layer; and
receiving a second probability that the feature vector corresponds to the particular phoneme or sequence of phonemes from the trained Gaussian-mixture model.

11. The method of claim 10, further comprising:
performing automatic speech recognition using the first probability to obtain a first transcription output;
performing automatic speech recognition using the second probability to obtain a second transcription output; and
performing automatic speech recognition system combination using the first transcription output and the second transcription output.

12. The method of claim 1, wherein the trained deep neural network is a deep neural network acoustic model, and wherein the first portion of the trained deep neural network and the trained Gaussian-mixture model form a Deep Neural Network-Gaussian-Mixture Model (DNN-GMM) acoustic model.

13. The method of claim 12, wherein a relative difference between an error rate of the deep neural network acoustic model and an error rate of the DNN-GMM acoustic model is less than 10 percent.

14. The method of claim 12, wherein an error rate of the DNN-GMM acoustic model with respect to the deep neural network acoustic model is greater than 1 percent.

15. The method of claim 12, wherein a number of hidden layers in the trained deep neural network and a number of parameters of the trained Gaussian-mixture model are such that a relative difference between an error rate of the deep neural network acoustic model and an error rate of the DNN-GMM acoustic model is less than 10 percent and an error rate of the DNN-GMM acoustic model with respect to the deep neural network acoustic model is greater than 1 percent.

16. The method of claim 1, wherein the set of training data includes a set of feature vectors, and wherein the set of feature vectors is labeled such that each feature vector of the set of feature vectors is associated with a target phoneme or sequence of phonemes.

17. The method of claim 16, wherein each feature vector of the set of feature vectors represents one or more segments of a speech signal.

18. A non-transitory computer-readable storage medium comprising instructions for:
training a deep neural network using a set of training data, wherein the deep neural network comprises an input layer, an output layer, and a plurality of hidden layers disposed between the input layer and the output layer, wherein training the deep neural network comprises:
determining, using the set of training data, a set of optimal weighting values of the deep neural network; and
storing the set of optimal weighting values in the memory;
linking a Gaussian-mixture model to a hidden layer of the trained deep neural network such that any feature vector outputted from the hidden layer is received by the Gaussian-mixture model; and
training the Gaussian-mixture model via a first portion of the trained deep neural network and using the set of training data, wherein the first portion of the trained deep neural network includes the input layer and the hidden layer, and wherein training the Gaussian-mixture model comprises:
determining, using the set of training data, a set of optimal parameter values of the Gaussian-mixture model; and
storing the set of optimal parameter values in the memory.

19. A computing device comprising:
one or more processors;
memory;
one or more programs, wherein the one or more programs are stored in the memory and configured to be executed by the one or more processors, the one or more programs including instructions for:
training a deep neural network using a set of training data, wherein the deep neural network comprises an input layer, an output layer, and a plurality of hidden layers disposed between the input layer and the output layer, wherein the means for training the deep neural network comprises:
determining, using the set of training data, a set of optimal weighting values of the deep neural network;
storing the set of optimal weighting values in the memory;
linking a Gaussian-mixture model to a hidden layer of the trained deep neural network such that any feature vector outputted from the hidden layer is received by the Gaussian-mixture model; and
training the Gaussian-mixture model via a first portion of the trained deep neural network and using the set of training data, wherein the first portion of the trained deep neural network includes the input layer and the hidden layer, and wherein the means for training the Gaussian-mixture model comprises:
determining, using the set of training data, a set of optimal parameter values of the Gaussian-mixture model; and
storing the set of optimal parameter values in the memory.

20. A method for generating complementary acoustic models for performing automatic speech recognition system combination, the method comprising:
at a device with a processor and memory storing instructions for execution by the processor:
training a deep neural network using a set of training data, wherein the deep neural network comprises an input layer, an output layer, and a plurality of hidden layers disposed between the input layer and the output layer, and wherein the trained deep neural network is a deep neural network acoustic model;
linking a Gaussian-mixture model to a hidden layer of the trained deep neural network such that any feature vector outputted from the hidden layer is received by the Gaussian-mixture model; and
training the Gaussian-mixture model via a first portion of the trained deep neural network and using the set of training data, wherein the first portion of the trained deep neural network includes the input layer and the hidden layer, and wherein the first portion of the trained deep neural network and the trained Gaussian-mixture model form a Deep Neural Network-Gaussian-Mixture Model (DNN-GMM) acoustic model.

21. The method of claim 20, wherein the hidden layer is a bottleneck layer, and wherein a number of units of the bottleneck layer is less than a number of units of the input layer.

22. The method of claim 20, wherein the first portion of the trained deep neural network is configured to perform a dimensionality reduction on a feature vector that is inputted at the input layer.

23. The method of claim 20, wherein linking the Gaussian-mixture model to the hidden layer is performed without severing a connection from the hidden layer to another layer of the trained deep neural network.

24. The method of claim 20, wherein any feature vector outputted from the hidden layer is received by a second portion of the trained deep neural network, the second portion of the trained deep neural network comprising the output layer.

25. A non-transitory computer-readable storage medium comprising computer-executable instructions for:
training a deep neural network using a set of training data, wherein the deep neural network comprises an input layer, an output layer, and a plurality of hidden layers disposed between the input layer and the output layer, and wherein the trained deep neural network is a deep neural network acoustic model;
linking a Gaussian-mixture model to a hidden layer of the trained deep neural network such that any feature vector outputted from the hidden layer is received by the Gaussian-mixture model; and
training the Gaussian-mixture model via a first portion of the trained deep neural network and using the set of training data, wherein the first portion of the trained deep neural network includes the input layer and the hidden layer, and wherein the first portion of the trained deep neural network and the trained Gaussian-mixture model form a Deep Neural Network-Gaussian-Mixture Model (DNN-GMM) acoustic model.
